(19) United States
(12) Patent Application Publication
(10) Pub. No.: US 2016/0334884 A1
(43) Pub. Date: Nov. 17, 2016

(54) Remote Sensitivity Adjustment in an Interactive Display System

(71) Applicant: Interphase Corporation, Dallas, TX (US)

(72) Inventors: Yoram Solomon, Plano, TX (US); Branislav Kisacanin, Plano, TX (US)

(73) Assignee: Interphase Corporation, Dallas, TX (US)

(21) Appl. No.: 15/107,515

(22) PCT Filed: Dec. 22, 2014
(86) PCT No.: PCT/US2014/071812

§ 371 Date: Jun. 23, 2016

Related U.S. Application Data
(60) Provisional application No. 61/920,816, filed on Dec. 26, 2013.

(51) Int. Cl. G06F 3/038; G06F 3/03; G06F 3/0354; G06F 3/0346

(52) U.S. Cl. CPC G06F 3/038; G06F 3/0346; G06F 3/0304; G06F 3/03542

(57) ABSTRACT

An interactive display system and method of operating the same including a remote pointing device for controlling items displayed at a display, in which movement of the device is adjusted according to distance from the display. Distance of the device from the display is determined, and a sensitivity reduction factor corresponding to that distance is calculated. Physical movement of the device is interpreted as movement of a cursor position at the display, with the extent of that movement adjusted according to the sensitivity reduction factor. An additional sensitivity reduction factor corresponding to the speed of movement of the device may also be incorporated into the adjustment of the cursor position.

### BACKGROUND OF THE INVENTION

This invention is in the field of interactive display systems. Embodiments of this invention are more specifically directed to the positioning of the location at a display to which a control device is pointing during the interactive operation of a computer system.

The ability of a speaker to communicate a message to an audience is generally enhanced by the use of visual information, in combination with the spoken word. In the modern era, the use of computers and associated display systems to generate and display visual information to audiences has become commonplace, for example by way of applications such as the POWERPOINT presentation software program available from Microsoft Corporation. For large audiences, such as in an auditorium environment, the display system is generally a projection system (either front or rear projection). For smaller audiences such as in a conference room or classroom environment, flat-panel (e.g., liquid crystal) displays have become popular, especially as the cost of these displays has fallen over recent years. New display technologies, such as small projectors (“pico-projectors”), which do not require a special screen and thus are even more readily deployed, are now reaching the market. For presentations to very small audiences (e.g., one or two people), the graphics display of a laptop computer may suffice to present the visual information. In any case, the combination of increasing computer power and better and larger displays, all at less cost, has increased the use of computer-based presentation systems, in a wide array of contexts (e.g., business, educational, legal, entertainment).

A typical computer-based presentation involves the speaker standing remotely from the display system, so as not to block the audience's view of the visual information. Because the visual presentation is computer-generated and computer-controlled, the presentation is capable of being interactively controlled to allow selection of visual content of particular importance to a specific audience, annotation or illustration of the visual information by the speaker during the presentation, and invocation of effects such as zooming, selecting links to information elsewhere in the presentation (or online), moving display elements from one display location to another, and the like. This interactivity greatly enhances the presentation, making it more interesting and engaging to the audience.

Hand-held devices that a remotely-positioned operator can use to point to, and interact with, the displayed visual information from a distance are known. One type of such devices are those of the “air mouse” type, which commonly rely on inertial sensors such as gyroscopes and accelerometers to transform relative motion of the handheld device into changes in cursor position at the display. These devices typically do not have any measure of distance from the device to the display surface. As a result, a given rotational or angular motion of the handheld device will be translated to the same movement of the cursor on the display, regardless of the distance of the device from the display. For example, consider an air mouse system in which a 30° angular movement of the handheld device is translated into a cursor motion of 512 pixels on a four-foot display with a resolution of 1024 pixels across its width (i.e., 30° movement translates causes the cursor to move about two feet). At one distance from the display (e.g., about 3½ feet from the display), this movement may feel natural to the user, such that the cursor moves to the point at which the user is actually pointing. But at other distances, the same natural cursor movement would not be sensed by the user. At larger distances from the display, movement of the device by the same 30° movement would naturally be assumed to move the cursor farther along the screen, but in these “air mouse” systems the cursor translation would be the same 512 pixels as at the closer distance. Conversely, at closer distances to the screen, the system would tend to move the cursor farther than would seem natural to the user. These effects would not only seem unnatural to the user, but would affect the ability of the user to accurately control the cursor, especially in “white board” applications in which the user is trying to draw or write on the display with the air mouse.

Another type of handheld devices for interacting with displayed content are those used in systems sometimes referred to as “interactive projectors”. These pen-like pointing devices include a camera that identifies visual targets on the display to determine the display location pointed to by the handheld device. These devices have been observed to have uncomfortably high sensitivity for users that are at a large distance from the display, however. At those large distances, a very small movement of the handheld device can translate into large movement at the display. On the other hand, at close distances, very large movement of the handheld device is required to move the cursor across the display.

By way of further background, an example of a handheld device useful in interactive display systems is the PENVEU wireless presentation tool available from Interphase Corporation. U.S. Pat. No. 8,217,997, issued Jul. 10, 2012, entitled “Interactive Display System”, commonly assigned herewith and incorporated herein by reference, describes an interactive display system including a wireless human interface device (“HID”) constructed as a handheld pointing device including a camera or other video capture system, and corresponding to the PENVEU wireless presentation tool. The pointing device captures images displayed by the computer, including one or more human-imperceptible positioning targets inserted by the computer into the displayed image data. The location, size, and orientation of the recovered positioning target identify the aiming point of the remote pointing device relative to the display.

The positioning of the aiming point of the pointing device according to the approach described in the above-referenced U.S. Pat. No. 8,217,997 is performed at a rate corresponding to the frame rate of the display system. More specifically, a new position can be determined as each new frame of data is displayed, by the combination of the new frame (and its positioning target) and the immediately previous frame (and its complementary positioning target). This approach works quite well in many situations, particularly in the context of navigating and controlling a graphical user interface in a computer system, such as pointing to and “clicking” icons, click-and-drag operations involving displayed windows and frames, and the like. A particular benefit of this approach described in U.S. Pat. No. 8,217,997, is that the positioning is “absolute”, in the sense that the result of the determination is a specific position on the display (e.g., pixel coordinates). The accuracy of the positioning carried out according to this approach is quite accurate over a wide range of distances between the display and the handheld device, for example ranging from in physical contact with the display screen to tens of feet away.

U.S. Patent Application Publication No. US 2014/0062881, published Mar. 6, 2014 from copending and commonly assigned U.S. patent application Ser. No. 14/018,695, incorporated herein by this reference, describes an interactive display system including a wireless pointing device and positioning circuitry capable of determining both absolute and relative positions of the display at which the pointing device is aimed. A comparison between the absolute and relative positions at a given time is used to compensate the relative position determined by the motion sensors, enabling both rapid and frequent positioning provided by the motion sensors and also the excellent accuracy provided by absolute positioning.

U.S. Patent Application Publication No. US 2014/0111433, published Apr. 24, 2014 from copending and commonly assigned U.S. patent application Ser. No. 14/056,286, incorporated herein by this reference, describes an interactive display system including a wireless pointing device and positioning circuitry capable of detecting motion of the pointing device between the times at which two frames are captured in order to identify the aiming point of the remote pointing device relative to the display. The ability of the pointing device to detect the positioning target is improved, according to the system and method described in this publication, by aligning the two captured images with one another according to the extent and direction of the detected motion.

### BRIEF SUMMARY OF THE INVENTION

Disclosed embodiments provide an interactive display system, and method of operating the same, that improves the ability of a user to interact with the system using a handheld remote device over a range of distances from the display.

Disclosed embodiments provide such a system and method that provides a natural cursor control experience to the user over a range of distances from the display.

Disclosed embodiments provide such a system and method that can be applied to handheld devices that use visual sensing, inertial sensors, or a combination of visual and inertial sensors.

Other objects and advantages of the disclosed embodiments will be apparent to those of ordinary skill in the art having reference to the following specification together with its drawings.

According to certain embodiments, an interactive display system and method of operating the same includes a pointing device including functions for identifying an aimed-at location of a display, for example that is to correspond to a cursor position at the display. The distance between the pointing device and the display is identified, and is used to determine a sensitivity reduction factor for that distance; the sensitivity reduction factor increases with increasing distance between the pointing device and display. Upon movement of the pointing device to move the cursor, the cursor is moved on the display by an amount corresponding to the detected pointing device movement, reduced by an amount corresponding to the sensitivity reduction factor.

### BRIEF DESCRIPTION OF THE SEVERAL VIEWS OF THE DRAWING

FIGS. 1a and 1b are schematic perspective views of an interactive display system used by a speaker at different distances from the display, according to disclosed embodiments.

FIGS. 2a and 2b are electrical diagrams, in block form, illustrating architectures of an interactive display system according to embodiments.

FIGS. 3a and 3b are schematic perspective views geometrically illustrating the operation of embodiments.

FIG. 4 is a flow diagram illustrating the operation of an interactive display system according to embodiments.

FIGS. 5a, 5b, and 5d are flow diagrams illustrating the operation of a process of determining a sensitivity reduction factor, according to embodiments.

FIG. 5c is a plot illustrating functions used in connection with the operation of identifying a sensitivity reduction factor based on range according to the embodiment shown in FIG. 5b.

FIG. 6 is a plot illustrating functions used in connection with the operation of identifying a sensitivity reduction factor based on motion speed according to an embodiment.

FIGS. 7a and 7b are schematic perspective views geometrically illustrating the operation of adjusting a cursor position according to embodiments.

### DETAILED DESCRIPTION OF THE INVENTION

This invention will be described in connection with one or more of its embodiments, namely as implemented into a computerized presentation system including a display visible by an audience, as it is contemplated that this invention will be particularly beneficial when applied to such a system. However, it is also contemplated that this invention can be useful in connection with other applications, such as gaming systems, general input by a user into a computer system, and the like. Accordingly, it is to be understood that the following description is provided by way of example only, and is not intended to limit the true scope of this invention as claimed.

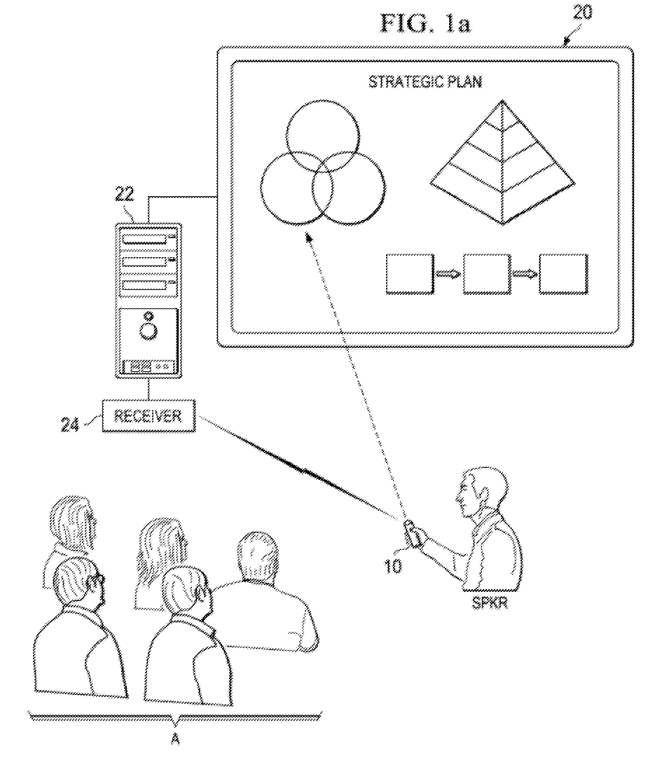

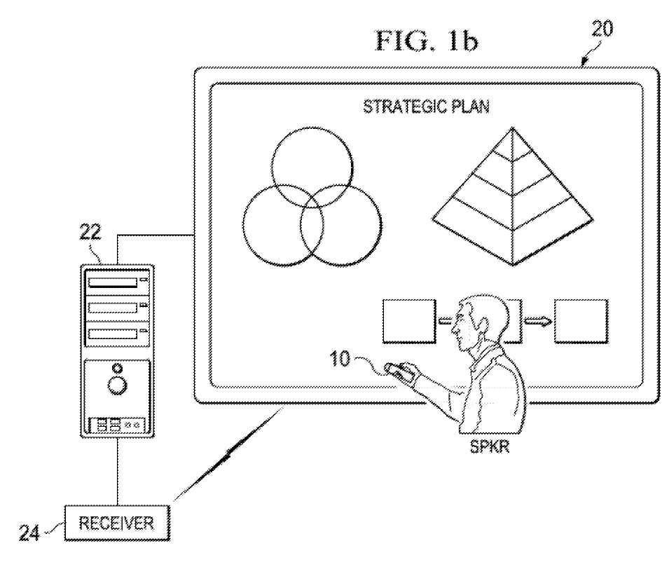

FIG. 1a illustrates a simplified example of an environment in which embodiments of this invention are useful. As shown in FIG. 1a, speaker SPKR is giving a live presentation to audience A, with the use of visual aids. In this case, the visual aids are in the form of computer graphics and text, generated by computer 22 and displayed on room-size graphics display 20, in a manner visible to audience A. As known in the art, such presentations are common in the business, educational, entertainment, and other contexts, with the particular audience size and system elements varying widely. The simplified example of FIG. 1a illustrates a business environment in which audience A includes several or more members viewing the presentation; of course, the size of the environment may vary from an auditorium, seating hundreds of audience members, to a single desk or table in which audience A consists of a single person.

The types of display 20 used for presenting the visual aids to audience A can also vary, often depending on the size of the presentation environment. In rooms ranging from conference rooms to large-scale auditoriums, display 20 may be a projection display, including a projector disposed either in front of or behind a display screen. In that environment, computer 22 would generate the visual aid image data and forward it to the projector. In smaller environments, display 20 may be an external flat-panel display, such as of the plasma or liquid crystal (LCD) type, directly driven by a graphics adapter in computer 22. For presentations to one or two audience members, computer 22 in the form of a laptop or desktop computer may simply use its own display 20 to present the visual information. Also for smaller audiences A, hand-held projectors (e.g., “pocket projectors” or “pico projectors”) are becoming more common, in which case the display screen may be a wall or white board.

The use of computer presentation software to generate and present graphics and text in the context of a presentation is now commonplace. A well-known example of such presentation software is the POWERPOINT software program available from Microsoft Corporation. In the environment of FIG. 1a, such presentation software will be executed by computer 22, with each slide in the presentation displayed on display 20 as shown in this example. Of course, the particular visual information need not be a previously created presentation executing at computer 22, but instead may be a web page accessed via computer 22; a desktop display including icons, program windows, and action buttons; video or movie content from a DVD or other storage device being read by computer 22.

In FIG. 1a, speaker SPKR is standing away from display 20, so as not to block the view of audience A and also to better engage audience A. According to embodiments of this invention, speaker SPKR uses a handheld human interface device (HID), in the form of pointing device 10, to remotely interact with the visual content displayed by computer 22 at display 20. As described in the above-incorporated U.S. Pat. No. 8,217,997 and U.S. Patent Application Publications No. US 2014/0062881 and No. US 2014/0111433, by way of example, speaker SPKR carries out this interaction by way of pointing device 10, which is capable of capturing all or part of the image at display 20 and of interacting with a pointed-to (or aimed-at) target location at that image. Pointing device 10 wirelessly communicates this pointed-to location at display 20 and other user commands from speaker SPKR, to receiver 24 and thus to computer 22. In this manner, according to embodiments of this invention, remote interactivity with computer 22 is carried out.

This interactive use of visual information displayed by display 20 provides speaker SPKR with the ability to extemporize the presentation as deemed useful with a particular audience A, to interface with active content (e.g., Internet links, active icons, virtual buttons, streaming video, and the like), and to actuate advanced graphics and control of the presentation, without requiring speaker SPKR to be seated at or otherwise “pinned” to computer 22. Another popular application of an interactive display system such as that shown in FIG. 1a is as a “white board” on which speaker SPKR may “draw” or “write”, using pointing device 10 (movement, clicks, drags, etc.) to actively draw content as annotations to the displayed content or on a blank screen. Other types of visual information useful in connection with embodiments of this invention will be apparent to those skilled in the art having reference to this specification.

FIG. 1b illustrates another use of the system and method of embodiments of this invention, in which speaker SPKR is interacting with the visual content from essentially at display 20. In this case, this interaction is carried out with pointing device 10 in actual physical contact with, or in close proximity to, display 20.

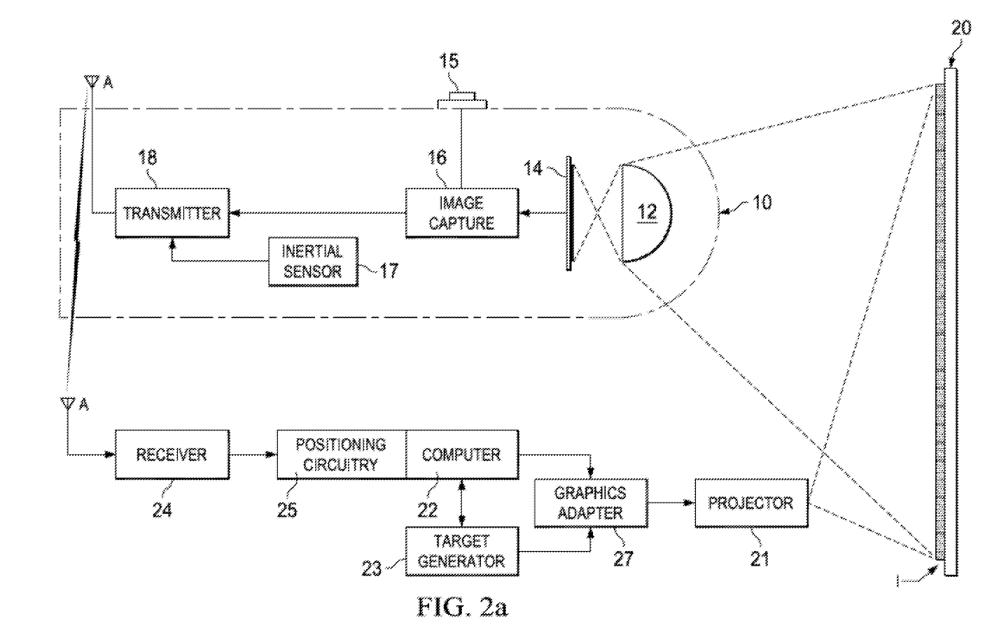

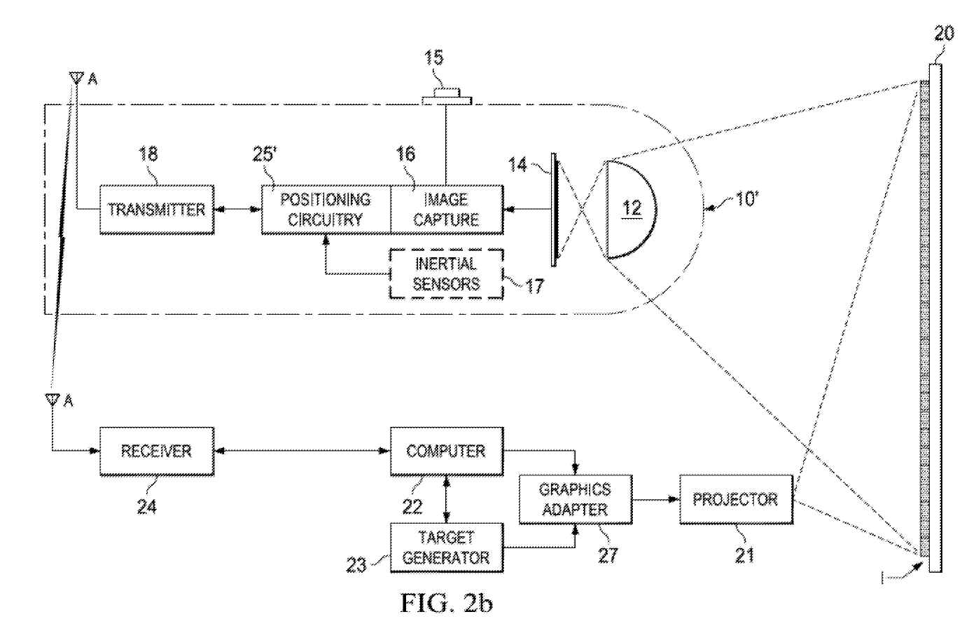

A generalized example of the construction of an interactive display system useful in environments such as those shown in FIGS. 1a and 1b, according to embodiments of this invention, will now be described with reference to FIGS. 2a and 2b. While the embodiments described in this specification will refer to the construction and operation of the interactive display system described in the above-incorporated U.S. Pat. No. 8,217,997 and U.S. Patent Application Publications No. US 2014/0062881 and No. US 2014/0111433, by way of example, it is contemplated that these embodiments may also be implemented in connection with other pointing devices, including those relying on inertial motion sensors, such as those of the “air mouse” type, and those relying on visual sensing, such as those used with systems of the “interactive projector” type. In that regard, it is contemplated that those skilled in the art having reference to this specification will be readily able to adapt the embodiments described herein to systems incorporating those and other alternative devices.

The example of such an interactive display system shown in FIG. 2a includes pointing device 10, projector 21, and display screen 20. In this embodiment of the invention, computer 22 includes the appropriate functionality for generating the graphics content displayed at display screen 20 by projector 21 for viewing by the audience (i.e., the “payload”), and that is to be interactively controlled by a human user via pointing device 10. In the architecture described in the above-incorporated U.S. Pat. No. 8,217,997, the payload image frame data from computer 22 is combined with positioning target image content generated by target generator function 23 for display at graphics display 20; those positioning targets can be captured by pointing device 10 and used by positioning circuitry 25 to deduce the location pointed to by pointing device 10. Graphics adapter 27 includes the appropriate functionality suitable for presenting image data including the combined payload image data and the positioning targets in the suitable display format, to projector 21. Projector 21 in turn projects the corresponding images I at display screen 20, in this projection example.

The particular construction of computer 22, positioning circuitry 25, target generator circuitry 23, and graphics adapter 27 can vary widely, from implemented within a single personal computer or workstation to implemented by separate functional systems for one or more of target generator 23, receiver 24, positioning circuitry 25, and graphics adapter 27 that are external to conventional computer 22. Other various alternative implementations of these functions are also contemplated. In any event, it is contemplated that computer 22, positioning circuitry 25, target generator 23, and other functions involved in the generation of the images and positioning targets displayed at graphics display 20, will include the appropriate program memory in the form of computer-readable media storing computer program instructions that, when executed by its processing circuitry, will carry out the various functions and operations of the embodiments described in this specification. It is contemplated that those skilled in the art having reference to this specification will be readily able to arrange the appropriate computer hardware and corresponding computer programs for implementation of these embodiments, without undue experimentation.

As shown in FIG. 2a, pointing device 10 includes a camera function consisting of optical system 12 and image sensor 14. Image capture subsystem 16 includes the appropriate circuitry known in the art for acquiring and storing a digital representation of the image captured at image sensor 14. In this example, pointing device 10 also includes actuator 15, which is a conventional push-button or other switch by way of which the user of pointing device 10 can provide user input in the nature of a mouse “click”, to actuate an image capture, or for other functions as will be apparent to those skilled in the art. Also in this example, one or more inertial sensors 17 such as accelerometers, magnetic sensors (i.e., for sensing orientation relative to the earth's magnetic field), gyroscopes, and the like are also included within pointing device 10, to assist or enhance navigation of the cursor position and control of the displayed content, as described in the above-incorporated U.S. Patent Application Publications No. US 2014/0062881 and No. US 2014/0111433.

In the architecture of FIG. 2a, pointing device 10 forwards signals that correspond to the captured image acquired by image capture subsystem 16 to positioning circuitry 25, via wireless transmitter 18 and antenna A. Receiver 24 receives those transmitted signals from pointing device 10 via its antenna A, performs the necessary demodulating, decoding, filtering, and other processing of the received signals into a form suitable for processing by positioning circuitry 25.

It is contemplated that the particular location of positioning circuitry 25 in the interactive display system of embodiments of this invention may vary from system to system. In the architecture of FIG. 2a, as described above, positioning circuitry 25 is deployed in combination with computer 22 and target generator function 23. Alternatively, as shown in FIG. 2b pointing device 10′ includes positioning circuitry 25′, which performs some or all of the computations involved in determining the location of (or near) display 20 at which it is currently pointing. Further in the alternative, transmitter 18 and receiver 24 may be each be implemented as transceivers to carry out bidirectional wireless communications with one another.

In either case, positioning circuitry 25 (hereinafter referring generally to positioning circuitry 25, 25′ described above) determines the location at display 20 at which pointing device 10 (hereinafter referring generally to pointing device 10, 10′ described above) is aimed, as will be described in detail below. As described in the above-incorporated U.S. Pat. No. 8,217,997, positioning circuitry 25 performs “absolute” positioning, in the sense that the pointed-to location at the display is determined with reference to a particular pixel position within the displayed image. In that example, image capture subsystem 16 captures images from two or more frames, those images including one or more positioning targets that are presented as patterned modulation of the intensity (e.g., variation in pixel intensity) in one display frame of the visual payload, followed by the same pattern but with the opposite modulation in a later (e.g., the next successive) frame. In addition, as described in the above-incorporated U.S. Patent Application Publications No. US 2014/0062881 and No. US 2014/0111433, movement of pointing device 10 sensed by inertial sensors 17 can be used to perform “relative” positioning of the pointed-to location of the display, to capture rapid movements of pointing device 10 and also to assist in the absolute positioning based on the captured images.

It is desirable for interactive display systems to enable the use of pointing device 10 to control the display of information over a wide range of distances from display 20, for example ranging from presentations in auditoriums and ballrooms to small-scale presentations in conference rooms or on a laptop or desktop computer display. It is therefore desirable for such interactive display systems to not unduly restrict the distance between the user and the display, while providing ease and accuracy of the interactive control of the displayed information.

However, as discussed above in the Background of the Invention, conventional pointing devices for interactive display systems are not well-suited for allowing interaction over a wide range of distances from the display. In short, these conventional systems have been observed to have uncomfortably high sensitivity when the pointing device is at a large distance from the display, such that small movements of the hand and the pointing device translate into large movement on the display, or uncomfortably low sensitivity when the pointing device is close to the display, such that large movements of the hand and pointing device are necessary to effect small movement on the display, or both. According to embodiments of this invention, the interactive display system is constructed and arranged so as to allow the user to accurately and comfortably interact with information displayed at display 20 whether from a remote distance as shown in FIG. 1a, or from essentially at display 20 as shown in FIG. 1b.

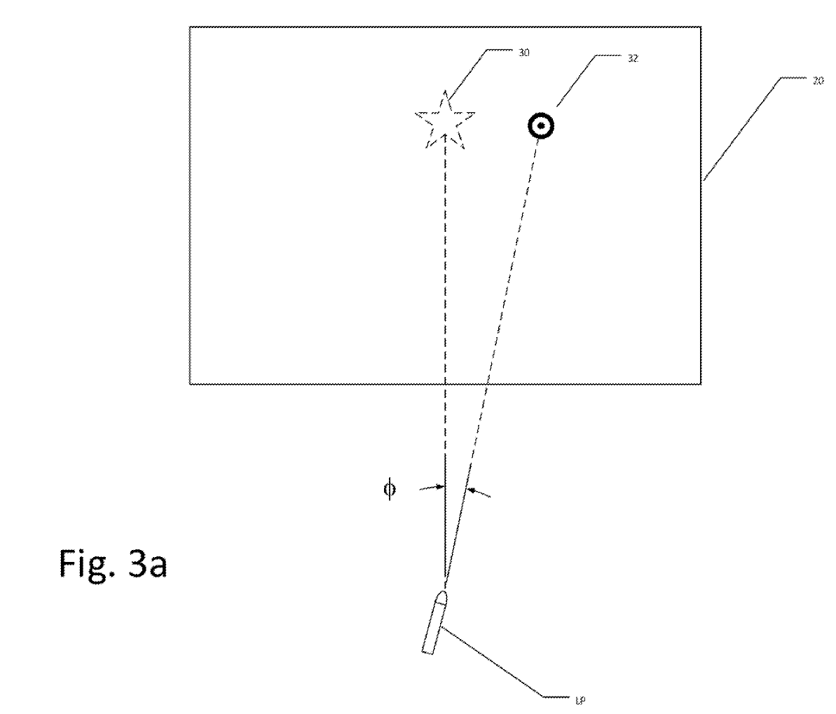

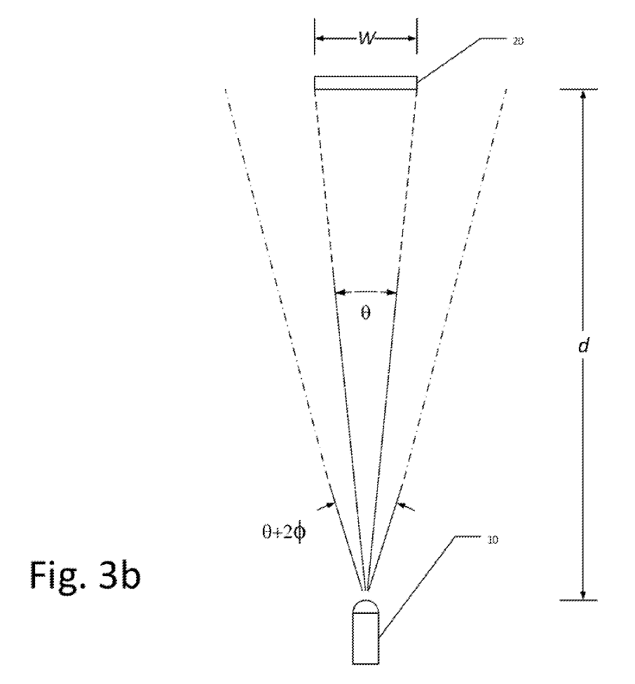

It has been observed, by way of experiment and in connection with this invention, that users of an interactive display system such as those described above can tolerate some level of error in the directional aim of pointing device 10, without consciously noticing the error. This experiment is illustrated schematically in FIG. 3a. In this experiment, a number of human subjects were asked to point laser pointer LP, in a natural pointing position such as used during a presentation, at feature 30 displayed on display 20 before turning on the laser. Upon the subject sensing that his or her hand is pointing laser pointer LP at feature 30, he or she would then turn on the laser to indicate the actual location of the screen at which the laser pointed was aimed. It was observed that most subjects had some level of error in their aim of laser pointer LP; that error is illustrated in FIG. 3a as angle of error φ; of course, the error may be in any direction relative to feature 30. Quantitatively, from an instance of this experiment, it was determined that this angle of error 4 was less than 9° for fewer than 5% of the subjects. Based on this experiment, it is believed that, in the context of the interactive display system such as that described above relative to FIGS. 1a and 1b, users would not naturally notice a positioning error of 9° in a cursor position on display 20 from the specific location at which pointing device is actually aimed. According to embodiments, this natural tolerance is used to provide a natural sense of navigation of cursor position for users over a wide range of distances from display 20.

FIG. 3b schematically illustrates the effect of the angle of error φ as applied to an interactive display system. In this example, display 20 has a width W, and pointing device 10 is located at a distance d from display 20. As such, display 20 of width W subtends an angle θ from the viewpoint of pointing device 10 at distance d; specifically, an angle θ=2 tan⁻¹[½ (W/d)]. For example, at a distance d=5W, the width W will subtend an angle θ of about 11.5°. From the standpoint of the user holding pointing device 10, this angle θ corresponds to the extent of the movement of pointing device 10 required to move a cursor across the full width W of display 20. For the example of pointing device 10 of FIG. 3b, at a distance d=5W from display 20, and assuming that a cursor is moved with the exact point to which pointing device 10 points, an angular movement of 11.5° would be sufficient to move the cursor from one lateral edge of display 20 to the other.

However, as demonstrated above, most human users are unable to sense a small angular error (e.g., on the order of 9° according to the experiment described above) in the precise point at which pointing device 10 is aimed relative to the point at which the user believes pointing device to be aimed. Accordingly, in the view of FIG. 3b, if the user believes pointing device 10 to be pointing at the left-hand edge of display 20, it may in fact be aimed as far as that angle of error (hereinafter referred to as tolerance angle φ) to the left of that edge of display 20; similarly, the user may believe pointing device 10 to be pointed at the right-hand edge of display 20 even if pointing device is aimed as far as angle of error 4 to the right of that edge. This realization can be reflected in the angular movement of pointing device 10 required to move the cursor position across width W of display 20 at distance d, by extending the movement of pointing device 10 by tolerance angle φ on either side of display 20. In other words, the angular movement required to move a cursor across the width of the display can be increased from the angle θ to the angle θ+2φ, without most users noticing the discrepancy. For the example of FIG. 3b with pointing device 10 at a distance d=5W from display 20, it is believed that an increase in the angular movement necessary to move a cursor from one lateral edge of display 20 to the other can be increased from θ=11.5° to θ+2φ=29.5° without feeling unnatural to the user.

Accordingly, it has been discovered, according to this invention, that the unperceived tolerance angle φ can be used to reduce the sensitivity of the positioning operation at increasing distances d from display 20 by translating a larger (and thus more controllable) hand and device movement to a smaller (and thus more precise) movement of the cursor at the display, while still providing a natural sense of cursor movement to the user.

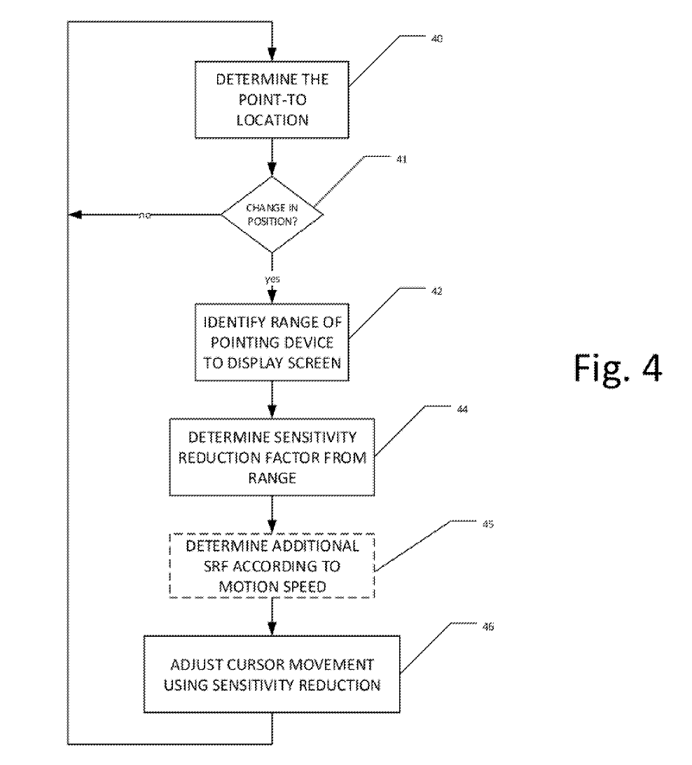

Referring now to FIG. 4, the operation of the interactive display system in selecting and moving an item displayed on a display screen according to these embodiments will now be described. For the example of the system described above relative to FIGS. 1a and 1b, it is contemplated that positioning circuitry 25 in the interactive display system will typically carry out these operations to effect the interactive control of the displayed information. In this regard, it is contemplated that program memory within or accessible to positioning circuitry 25 can store program instructions that are executable by programmable logic in positioning circuitry 25, or that positioning circuitry 25 is constructed with the appropriate logic functions, to carry out these operations described in this specification. As noted above, positioning circuitry 25 may be located at or within computer 22 (as shown in FIG. 2a by positioning circuitry 25), or may be part of pointing device 10′ (as shown in FIG. 2b by positioning circuitry 25′), or may be distributed throughout the system with portions at both pointing device 10, 10′ and at computer 22, each performing some of these functions now to be described. Accordingly, the location or arrangement of positioning circuitry 25 is not of particular importance according to these embodiments.

The operation according to these embodiments begins with process 40 in FIG. 4, in which positioning circuitry 25 determines the physical location of (or near) display 20 at which pointing device 10 is aimed. For purposes of this description, this physically aimed-at location will be referred to as the “point-to location”. In contrast, this description will refer to the location of an item displayed at display 20 that is being controlled by movement of pointing device 10 as the “cursor position”, it being understood that the particular item displayed at this cursor position of display 20 is not necessarily a “cursor”, but alternatively may be an icon, text element, free-form figure such as a line or text being “written” by way of pointing device 10 (e.g., in a “white board” application of the interactive display system), or simply a location of display 20 without any particular item being displayed. According to these embodiments, the movement of the point-to location of pointing device 10 will control movement of the cursor position at display 20 at a sensitivity that varies with the distance of pointing device 10 from display 20, so as to provide a natural sense of cursor movement to the user.

Positioning process 40 may be performed in any one of a number of ways, depending on the techniques implemented in the interactive display system. Conventional positioning techniques known in the art as used in connection with pointing devices of the “air mouse” and those used with “interactive projectors” may be used. For the interactive display system described above relative to FIGS. 1a and 1b, non-human-visible positioning targets are combined with the payload information displayed at display 20, and detected by positioning circuitry 25 with the assistance of image capture subsystem 16 and (if implemented) inertial sensors 17, as described in the above-incorporated U.S. Pat. No. 8,217,997 and U.S. Patent Application Publications No. US 2014/0062881 and No. US 2014/0111433. It is contemplated that those skilled in the art having reference to this specification can readily develop the appropriate algorithms and methods for carrying out process 40, without undue experimentation. However carried out, the point-to location at which pointing device 10 is aimed is determined in this process 40.

Decision 41 then determines whether the current point-to location determined in the most recent instance of process 40 is different from the previous point-to location, to determine whether movement of pointing device 10 has occurred. If not (decision 41 is “no”), control returns to process 40 to perform the next instance of positioning process 40. For the case of visual (absolute) positioning, this next instance may occur with the next frame of image data displayed at display 20. For the case of relative motion sensing, positioning process 40 and decision 41 may be performed by determining whether inertial sensors 17 have detected any movement of pointing device 10, retaining the previously determined point-to location if not.

If the point-to location has changed (decision 41 returns a “yes” result), process 42 is next performed by pointing device 10 in combination with positioning circuitry 25 to identify the distance of pointing device 10 from display 20 (i.e., the “range” of pointing device 10). It is contemplated the range of pointing device 10 may be determined in process 42 in any one of a number of ways.

For example, as described in the above-incorporated U.S. Pat. No. 8,217,997, positioning circuitry 25 may determine the range of pointing device from one or more attributes of a positioning target image contained within the image captured by image capture subsystem 16 of pointing device. These attributes can include the size of the positioning target in the image captured by pointing device 10 relative to the field of view of image sensor 14, which can give an indication of how close pointing device 10 is to display 20 at the time of image capture. Other attributes such as the location of the positioning target within the field of view of that captured image relative to other features in the displayed content, including other positioning targets, can additionally or alternatively be used to make that determination. For example, if pointing device 10 is relatively close to display 20, its field of view will be relatively small, and may include only a single positioning target that appears to be relatively large within the image captured by pointing device. In this case, positioning circuitry 25 can deduce that pointing device 10 is only a short distance away from display 20. Conversely, if pointing device 10 is relatively far away from display 20, its field of view will be larger and may include multiple positioning targets that appear to be relatively small within the images captured by pointing device 10, in which case positioning circuitry 25 can deduce that pointing device 10 is relatively far from display 20.

Positioning circuitry 25 may carry this function out by comparing the captured image against the video data forming the displayed image at the corresponding time, either by way of a direct comparison of video data (i.e., comparing a bit map of the captured image with a bit map of the displayed image) or by identifying the size of the positioning target and comparing that size with the size of the positioning target as displayed. A specific example of an approach based on relative sizes of the positioning target may be considered as a determination of viewing angle θ. In this approach, the angle subtended by display 20 within the field of view of image capture sub-system 16 of pointing device 10 may be calculated by considering the relative size of a displayed item (e.g., a positioning target) at image sensor 14 relative to the size of that item at display 20, taking into account the relative resolution of image sensor 14 and display 20, and also the focal distance of pointing device 10 in acquiring its images. A specific example of this approach to determining range in process 42 will be provided below.

Other alternative techniques may be used to perform range determination process 42 according to these embodiments. In some implementations, the user may manually input his or her distance (and that of pointing device 10) from display 20 by simply setting a multi-position switch (e.g., corresponding to “at screen”, “conference room”, “auditorium”). Other approaches for determining the range of pointing device 10 to display 20 are contemplated, such as use of a laser range finder, time of flight (ToF) sensor, an indoor positioning system (IPS) or high-resolution global positioning system (GPS). It is contemplated that those skilled in the art having reference to this specification, or with knowledge of conventional techniques, can readily develop the appropriate algorithms and methods for determining the range of pointing device 10 from display 20 in process 42, without undue experimentation.

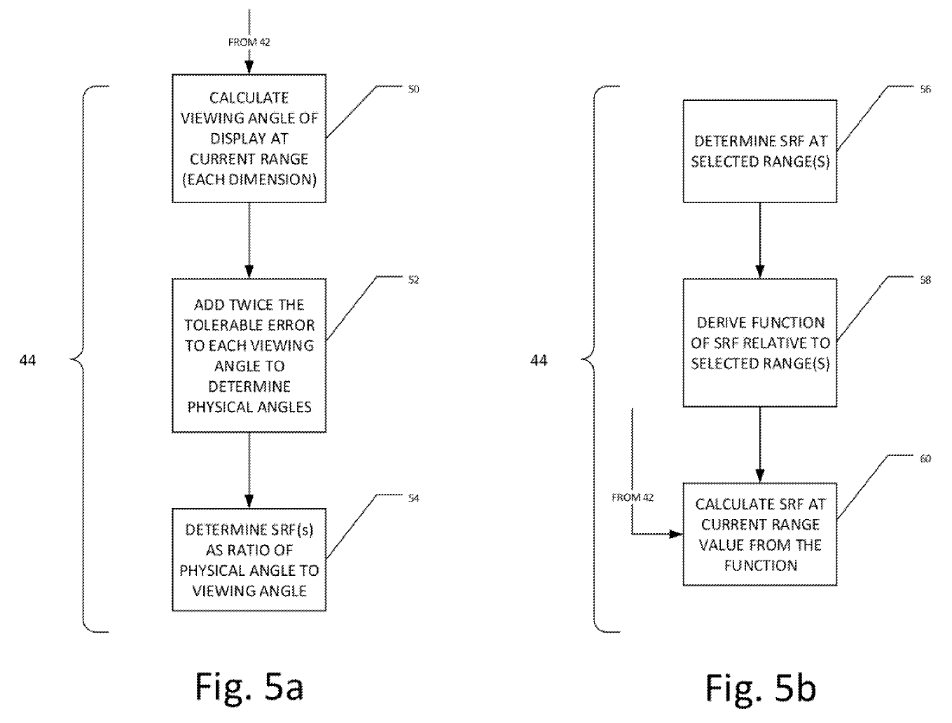

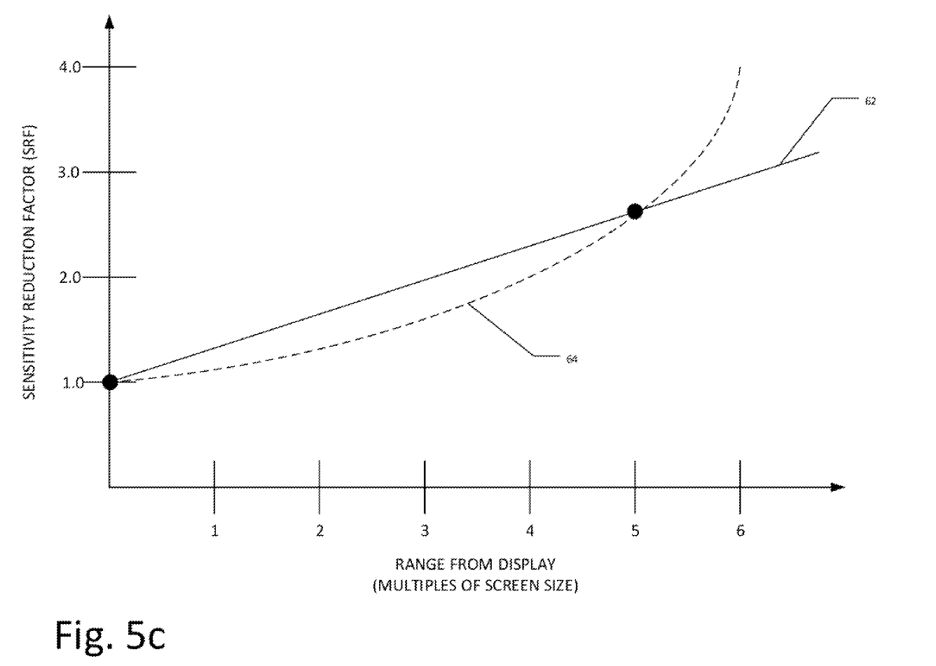

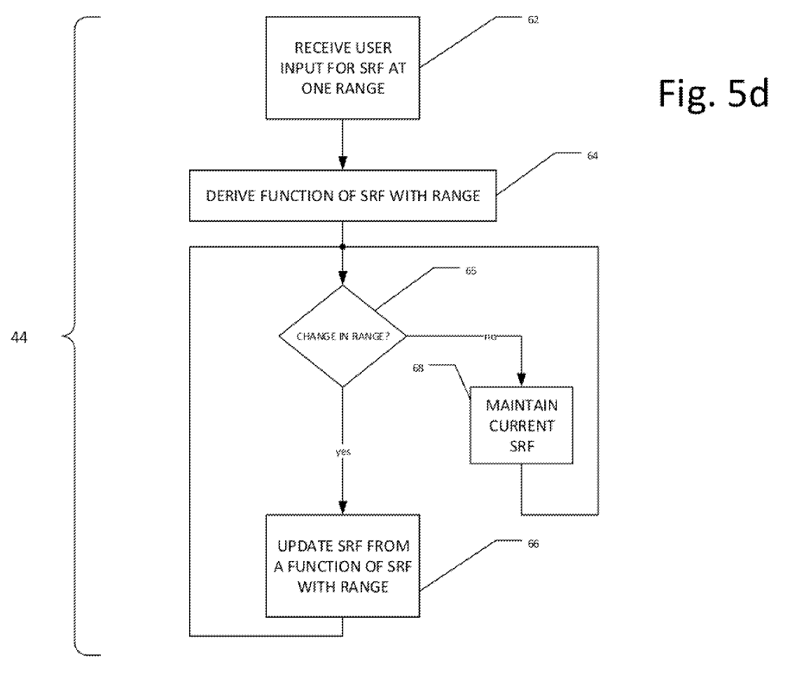

Once the range is determined in process 42, positioning circuitry 25 then determines a sensitivity reduction factor (SRF) in process 44. According to these embodiments, this sensitivity reduction factor reduces the sensitivity of the interactive display system to movement of pointing device 10 at larger distances between it and display 20, so that navigation of a cursor, icon, or other item along display 20 using pointing device 10 is more natural and comfortable to the user over a range of those distances. According to these embodiments, several alternative approaches to SRF determination process 44 are contemplated, as will be described by way of examples shown in FIGS. 5a through 5d.

In the embodiment shown in FIG. 5a, SRF determination process 44 begins with process 50, in which positioning circuitry 25 identifies viewing angles of display 20 at the range determined in process 42. In this embodiment, the viewing angles refer to the angular motion of pointing device 10 to move the point-to location (i.e., the location aimed-at by pointing device 10) from one edge of display 20 to the other; it is contemplated that viewing angles will be determined in process 44 for both the horizontal and vertical dimensions of display 20. In the example described above in which range determination process 42 involves the determination of the viewing angle θ, then this process 50 is already complete.

Alternatively, if process 42 does not derive viewing angle θ, process 50 may be carried out based on the range determined in process 42 and the dimensions of display 20, for example as indicated from input data entered via computer 22. Positioning circuitry 25 may then calculate the viewing angles of display 20 in each of the horizontal and vertical directions using rudimentary geometric calculations. Alternatively, positioning circuitry 25 or another function in the interactive display system may include a look-up table in memory by way of which, for given dimensions of display 20, the range determined in process 42 can retrieve the corresponding viewing angles. This look-up table may be indexed by the detected range as a multiple of the display dimension (e.g., a range of five times the width of display 20 subtends a horizontal viewing angle of about 11.5°, as noted above).

As discussed above, it has been discovered that some angular error is generally tolerable by human users in the operation of pointing device 10 at a distance from display 20. The example discussed above found this tolerance angle φ to be about 9°, but of course different user populations and different applications of the interactive display system may present different values of this tolerance angle φ. This tolerance angle φ may vary from the 9° noted above, depending on the particular system and pointing device used, or on particular installations or populations of users, or the like; in addition, tolerance angle φ may be different in the vertical direction than in the horizontal direction, or may differ for upward movement from that for downward movement, or for leftward movement from that for rightward movement, etc. In any case, some memory location in or accessible to positioning device 25 stores the tolerable error value for the particular interactive display system according to this embodiment. According to this embodiment, positioning circuitry 25 executes process 52 to determine the factor by which the sensitivity of movement of pointing device 10 is to be reduced, by combining this tolerance angle with the viewing angle calculated in process 50. This sensitivity reduction factor is thus based on a “physical angle” that defines the angular motion required to move the point-to location from one edge of display 20 to the other. Specifically, process 52 in this embodiment adds the tolerable error reflected by tolerance angle φ to the viewing angle in each of the horizontal and vertical dimensions, to determine physical angles for each dimension. FIG. 3b illustrates this physical angle θ+2φ for one dimension of display 20 as corresponding to the viewing angle of θ for that dimension plus the tolerance angle φ on either side.

Once the viewing angles and physical angles are determined in processes 50, 52, positioning circuitry 25 then executes process 54 to determine a sensitivity reduction factor (SRF) in each of the horizontal and vertical dimensions. According to this embodiment, the SRF is calculated, for each dimension, as the ratio of the physical angle to the viewing angle in that dimension. For example, the SRF may be calculated in process 54 as the ratio of the tangent of one-half the physical angle θ+2φ to the tangent of the tolerance angle φ. In this approach, these SRFs that depend on the range of pointing device 10 to display 20 will be greater than unity (i.e., for a range of zero, the SRF will be 1.0).

According to another embodiment of process 44, as will now be described relative to FIG. 5b, the SRFs are determined geometrically as in the embodiment of FIG. 5a, but are instead determined according to some linear or non-linear function of the range detected in process 42. In this embodiment, the relationship between SRF and range can be derived in advance, including at the time of manufacture of the interactive display system; alternatively, this relationship may be derived or selected at the time of use or during multiple uses of the interactive display system in a particular application. As such, it is contemplated that certain processes in this embodiment may not be performed by positioning circuitry 25 in each instance of the interactive display system, but rather may be performed using an experimental setup, computer, or other appropriate apparatus prior to use of the system.

In any case, according to this embodiment, the SRFs at one or more selected ranges are determined in process 56. Process 56 may be performed by performing one or more calculations of SRF based on geometric considerations using assumed tolerance angles φ, or according to other approaches. Considering the examples discussed above in this specification, examples of the SRFs determined in process 56 may include an SRF of 2.6 at a range of five times the relevant dimension (e.g., width) of display 20, and an SRF of 1.0 at zero distance from the display. FIG. 5c illustrates these two points on a coordinate system of SRF versus range. In process 58, a selected function shape is then applied to the data points calculated in process 56 to derive the desired function of SRF with respect to range. This function derived in process 58 may be a linear function as shown by line 62 of FIG. 5c, or a non-linear function as shown by curve 64 of FIG. 5c. For the example of the functions shown by line 62 and curve 64, the SRFs increase with increasing range of pointing device 10 from display 20, which translates into a decrease in the movement of a cursor position at display 20 for a given movement of pointing device 10. Of course, while both line 62 and curve 64 lie on the data points determined in process 56 in this example, it is contemplated that the deriving of the function in process 58 may be determined by a conventional “best fit” regression or other algorithm, particularly if a number of SRF versus range points are determined in process 56.

Once the function of SRF with respect to range has been derived in process 58 according to this embodiment, process 60 is then performed during use of the interactive display system upon receipt of a range as determined in process 42. Specifically, the range determined in process 42 (for each relevant dimension, as noted above) is applied to the function derived in process 58 to determine the appropriate SRF value or values. Again, these SRFs will tend to increase with the range of pointing device 10 from display 20, such that the further that the user is from display 20, the less sensitive the system will be to movement of pointing device 10.

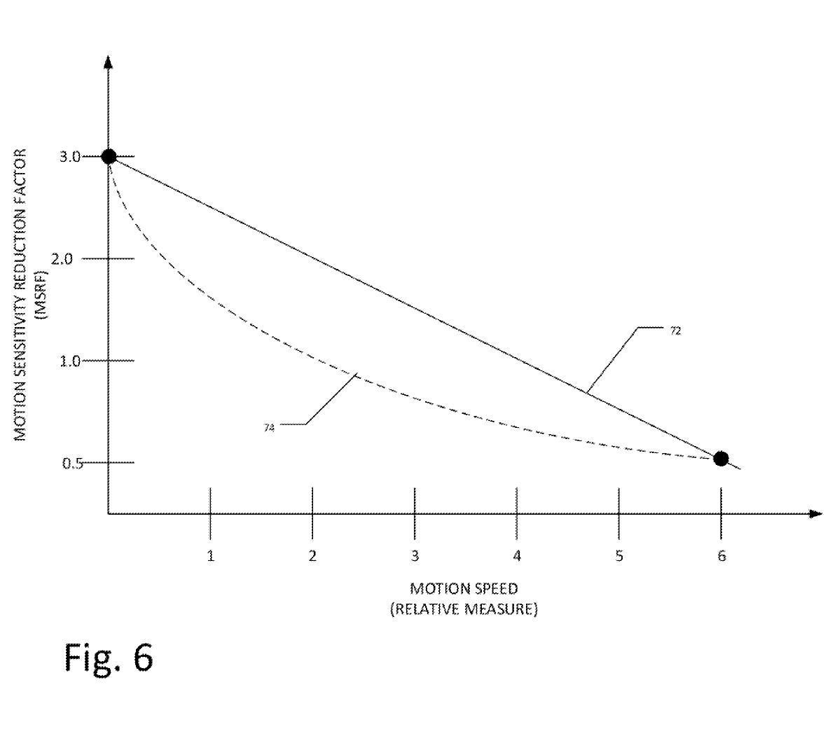

Referring now to FIG. 5d, SRF determination process 44 according to another embodiment will be described. This embodiment relies on manual determination of the sensitivity of movement for pointing device 10. In process 62 shown in FIG. 5d, the manual determination is provided to the interactive display system by way of a user input. For example, process 62 may be provided by a user actually using pointing device 10, and moving a dial or switch on pointing device 10 to “dial in” a comfortable level of sensitivity at the range at which the user intends to operate the system. Alternatively, user inputs may be provided in process 62 in setting up the interactive display system in an environment, with that input stored in positioning circuitry 25 or otherwise available for later use in SRF determination process 44. Other alternative approaches to process 62 will be apparent to those skilled in the art having reference to this specification. In any case, this user input of SRF for a particular range is used to define a function of SRF in process 64, in similar fashion as described above in connection with process 58 of FIGS. 6b and 6c. Again, the function derived in process 64 may be linear or non-linear as desired.

Decision 65 of this embodiment detects whether the range determined in process 42 has changed, either from that for which the user input was provided in process 62 or from one for which the SRF has been previously determined. If there has been a change in range (decision 65 is “yes”), the current SRF is updated for the new range in process 66. In this embodiment, process 68 updates the SRF by applying the current value of the range from process 42 to the function derived in process 63, in similar fashion as described above in connection with process 60 of FIG. 5b. If there has been no change in range (decision 65 is “no”), then the current value of SRF is maintained. In either case, the operation of process 42 in detecting the current range of pointing device 10 from display 20, and the determination of decision 65, is repeated so as to detect changes in the range and to update the SRF accordingly.

In addition, it is contemplated that the user may also be able to adjust the sensitivity of movement for pointing device 10 during use. In that alternative implementation, new inputs from the user may be received in process 62, in which case the SRF function would be redefined in process 64 accordingly.

Each of the above embodiments are described for the case in which separate sensitivity reduction factors (SRFs) are derived for the horizontal and vertical dimensions, assuming a rectangular display. Alternatively, it is contemplated that it may be sufficient, in some applications, to derive and use a single SRF value for both dimensions. For example, the SRF may be determined according to any of these embodiments for either the larger or smaller of the dimensions of display 20, as desired, with the same SRT value as derived applied to movement in either direction.

Referring back to FIG. 4, optional process 45 may now be performed as desired. In process 45, an additional sensitivity reduction factor, namely a motion sensitivity reduction factor (MSRF), that is based on the speed of movement of pointing device 10, rather than its range, is determined. This reduction in sensitivity may be useful in some applications of the interactive display system, such as “white board” applications, in which precise control of the cursor position is desired. It is natural for some users to slow the movement of a mouse or other pointing device when trying to precisely drag, draw, or carry out other cursor movements on a display; at such a slow speed of movement, it may therefore be desirable to have a low sensitivity of the system to movement of the pointing device so that larger movements of the device translate into smaller movements of the cursor. According to this embodiment, optional process 45 operates to detect the speed of movement of pointing device 10, and derives motion sensitivity reduction factor MSRF as a function of that motion speed. Detection of the speed of movement may be carried out by positioning circuitry 25 based on inputs from either or both of inertial sensors 17 or image capture sub-system 16, for example as described in the above-incorporated U.S. Patent Application Publication No. US 2014/0062881.

One approach that may be used to carry out optional process 45 is similar to that described above relative to FIG. 5b, with the speed of movement of pointing device 10 used as the independent variable instead of range. For example, given one or more values of the MSRF at particular motion speeds, analogously to process 56, a function of this MSRF with respect to motion speed can be derived, analogously to process 58. FIG. 6 illustrates examples of linear and non-linear functions of this additional SRF with motion speed, as shown by line 72 and curve 74. In each case, the MSRF value varies inversely with motion speed, such that higher sensitivity reduction (decreased movement of a cursor position at display 20 for a given movement of pointing device 10) is applied at lower speeds of movement of pointing device 10, and with lower sensitivity reduction (increased movement of a cursor position at display 20 for a given movement of pointing device 10) applied at higher speeds of movement. Indeed, as evident from FIG. 6, it is contemplated that the motion sensitivity reduction factor determined in optional process 45 can be below unity, such that movement the cursor position at display 20 may be amplified, rather than attenuated, at higher speeds of movement of pointing device 10; for example, a rapid gesture with pointing device 10 may thus be interpreted as moving the cursor position fully across the width of display 20. In any case, the detected speed of movement of pointing device 10 can then be applied to the derived MSRF function to determine the value of this motion sensitivity reduction factor, analogously to process 60.

If optional process 45 is implemented, it is contemplated that the resulting motion sensitivity reduction factor will typically be combined with the sensitivity reduction factor based on range, for example by multiplying the two factors, to provide a single sensitivity reduction factor for use in adjusting the movement of the cursor position in process 46 of FIG. 4, as will now be described.

Adjustment of the cursor movement in process 46 may be based on any of the sensors contained within pointing device 10 and that are used in the positioning determination carried out by positioning circuitry 25. As discussed above, these sensors include image capture sub-system 16 that are involved in detecting the point-to location in an absolute sense (i.e., determining the location at which pointing device 10 is aimed), and inertial sensors 17 that are involved in detecting the point-to location relative to a previously determined position. As will now be described, adjustment of the results of either or both of these relative and absolute positioning approaches will be applied, in process 46, to determine the cursor position at display 20 that is being controlled by the movement of pointing device 10.

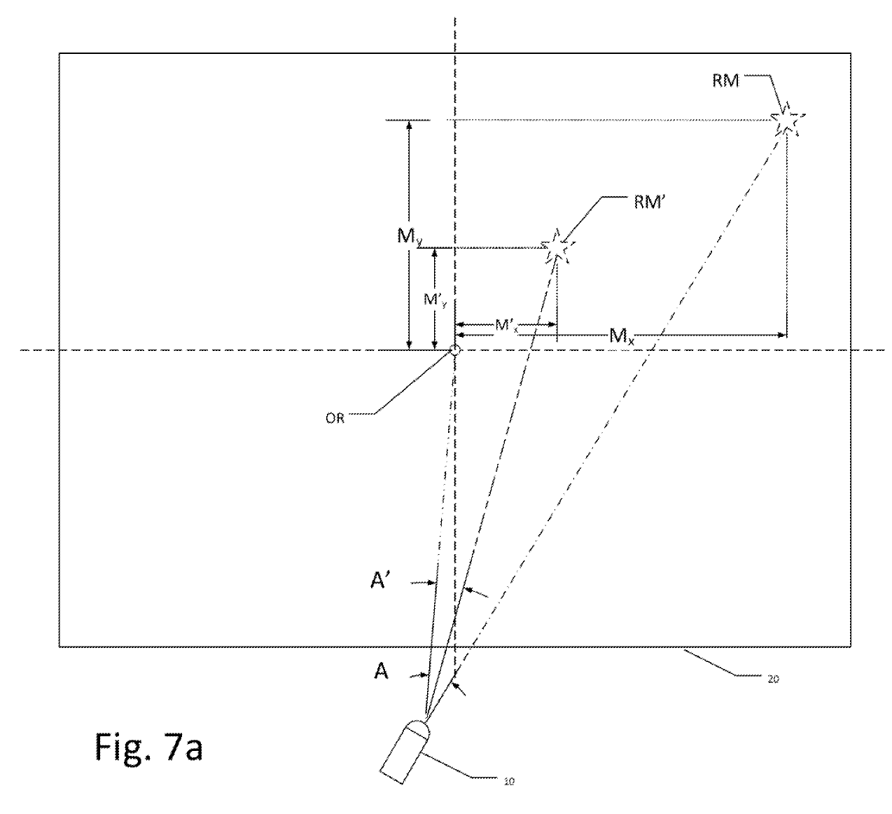

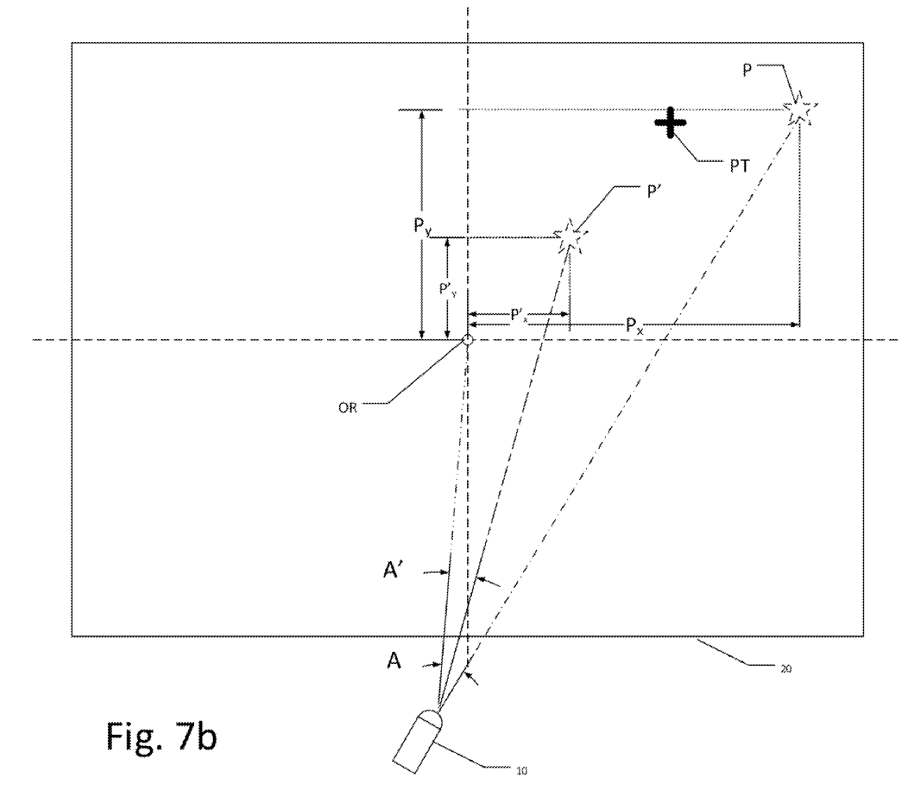

For the case of relative motion sensing involved in detecting a changed point-to location due to movement of pointing device 10 (processes 40, 41 of FIG. 4), it is contemplated that the motion of pointing device 10 may be sensed as a relative linear motion with components in both the horizontal x and vertical y directions, or as a relative angular motion. FIG. 7a illustrates an example of the manner in which adjustment process 46 operates to adjust the relative motion of the cursor position from origin OR in the center of display 20. In this example, the motion of pointing device 10 at the range determined in process 42 indicates movement of the cursor position from origin OR to location RM if no sensitivity adjustment is applied. In this example, however, the SRF determined in process 44 (and process 45, if performed) is greater than unity, such that the sensitivity of positioning circuitry 25 to this movement of pointing device 10 is reduced to move the cursor position, as displayed at display 20, from origin OR to location RM′.

If linear relative motion detection is carried out by pointing device 10 and positioning circuitry 25, the unadjusted movement of the point-to location from origin OR to location RM can be expressed by its x and y components, shown in FIG. 7a as distances Mₓ and M_{y}, respectively. These distances may be expressed as linear distances at the surface of display 20, or as pixel-distances at the surface of display 20 given its resolution. These distances are relative distances, in that they represent movement of the point-to location from a previous location, rather than absolute distances from origin OR. For sensitivity reduction factors SRFₓ and SRF_{y} determined in process 44 (and 45) for the x and y directions, respectively, the adjustment of process 46 in this embodiment can readily derive adjusted distances M′ₓ and M′_{y} as:

M′ₓ=Mₓ/SRFₓ

M′_{y}=M_{y}/SRF_{y}

These adjusted distances M′ₓ and M′_{y} are then used to move the cursor position at display 20 in response to the detected relative motion. The process of FIG. 4 can then be repeated from detection of the next point-to location in process 40.

As mentioned above, the relative motion detected by processes 40, 41 may be considered as an angular motion of pointing device 10, in which the relative motion is considered in the form of a particular angle subtended by the movement of the aim of pointing device 10, with pointing device 10 itself as the vertex. As shown also in FIG. 7a, the angular movement of the aim of pointing device 10 (i.e., the point-to location), prior to adjustment, is shown by angle A. This angle A can be considered as having x and y components Aₓ, A_{y}, respectively, similarly as discussed above relative to the linear relative movement case; these components Aₓ, A_{y} are not shown in FIG. 7a for the sake of clarity. Adjustment process 46 in this angular relative motion case applies sensitivity reduction factors SRFₓ and SRF_{y} determined in process 44 (and 45) to these angular components Aₓ, A_{y}, to produce adjusted angular components A′ₓ, A′_{y} from these relationships:

$${SRF}_{x} = \frac{tan ( {A}_{x} )}{tan ( {A}_{x}^{′} )}$$

$${SRF}_{y} = \frac{tan ( {A}_{y} )}{tan ( {A}_{y}^{′} )}$$

The resulting adjusted angles A′ₓ and A′_{y} are then used to move the cursor position at display 20 in response to the detected relative motion, and the process of FIG. 4 is repeated from process 40.

Adjustment process 46 as applied to changes detected by the absolute positioning of the point-to location is somewhat different, according to this embodiment. As described in the above-incorporated U.S. Pat. No. 8,217,997, the process of absolute positioning is based on the detection of positioning targets within the field of view of image capture sub-system 16 of pointing device 10, and in placing the cursor position within display 20 as a result. However, the positioning target or targets are not necessarily at the center of the field of view of pointing device 10. FIG. 7b illustrates this situation by way of point-to location P, which is the physically aimed-at location of display 20 (i.e., without or prior to adjustment process 46) and positioning target PT is the positioning target at display 20 within the field of view of pointing device 10 when aimed at point-to location P. Because, according to this embodiment, the sensitivity of movement of pointing device 10 is to be reduced at the current range of pointing device 10 from display 20, adjustment process 46 will result in adjusted cursor position P′ that is shown at display 20.

More specifically in this absolute positioning case, positioning circuitry 25 determines the point-to location P of display 20, in process 40, relative to that of positioning target PT within the field of view. According to this embodiment, in which sensitivity reduction is applied, this location P may actually be outside of the bounds of display 20, yet “point” to a cursor position within display 20. Referring to FIG. 7b, point-to location P is detected by positioning circuitry 25 in process 40, using positioning target PT, as somewhere to the upper right of origin OR, with that location P expressed as component distances Pₓ, P_{y} (either as linear distances or pixel-distances) from origin OR, or as an angle A (or components) from the vertex of pointing device 10 relative to origin OR. In this absolute positioning case, these distances and angles are absolute distances relative to origin OR, rather than as movement relative to a previous point-to location at origin OR. The SRFs determined in process 44 are then applied to these distances or angles (i.e., their components) as described above for the relative motion case of FIG. 7a, to place adjusted cursor position P′ as shown in FIG. 7b.

In an interactive display system such as described in the above-incorporated U.S. Patent Application Publication No. US 2014/0062881, both absolute and relative positioning are utilized. In that system, it may be that relative motion sensing is primarily used in the positioning determination, because of its speed of response, with that relative positioning corrected based on results from the absolute positioning. In that combined absolute and relative positioning context, reduction of the sensitivity according to these embodiments is preferably applied to both of the absolute and relative positioning. This would avoid situations in which the correlation of the absolute and relative positioning results is performed incorrectly. For example, if sensitivity reduction is applied only to relative positioning, the corrections from absolute positioning (without sensitivity reduction) may cause the cursor position to “jump” to the physically aimed-at location of the display, which may even be off-screen. As such, it is contemplated that the full benefit of sensitivity reduction according to these embodiments will be attained in these combined systems by applying that adjustment to both of the relative motion and absolute positioning systems must be corrected in a way that the calculated reduced-sensitivity cursor position will be the same for both subsystems.

An example of the calculation of a sensitivity-adjusted cursor position for the case of absolute positioning will be instructive. This example will be carried out for one dimension (the x dimension); those skilled in the art having reference to this specification will be readily able to apply the same calculations in the vertical y direction. Consider for this example an interactive display system in which the horizontal resolution of image capture sub-system 16 at pointing device 10 is R_{c}=640 pixels, with a field of view of W_{c}=55 mm in width and a focal distance of F_{c}=50.8 mm, and in which display 20 has a resolution R_{d}=1024 pixels. The tolerance angle φ in this example is expressed as angle A_{R}=9°. Also in this example, a positioning target seen at image sensor 14 has size T_{c}=80 camera pixels as corresponding to a positioning target displayed at display 20 having a size T_{d}=768 display pixels. This positioning target is displayed on display 20 at a target center location TC_{d}=0 (i.e., centered at the center of display 20) with that target center offset from the center of sensor 14 of pointing device by TCO_{d}=+35 pixels (i.e., 35 pixels to the right of center).

Positioning circuitry 25 can determine the range of pointing device 10 from display 20 in process 42 by calculating the viewing angle A_{FOV} of the width of display 20 in the captured image as:

$${A}_{FOV} = {tan}^{- 1} ( \frac{{W}_{c} \times {T}_{c} \times {R}_{d}}{2 {R}_{c} \times {F}_{c} \times {T}_{d}} )$$

which, in the particular example described above, comes to 5.155°. This angle represents the angular offset of one edge (left or right, in this horizontal case) from the center of display, as seen by image capture sub-system 16 of pointing device 10; as such, viewing angle A_{FOV} in this example is ½ that of viewing angle θ in FIG. 3b.

Sensitivity reduction factor determination process 44 can then be performed by positioning circuitry 25 adding the tolerance angle A_{R} to this viewing angle A_{FOV}:

$$SRF = \frac{tan ( {A}_{FOV} + {A}_{R} )}{tan ( {A}_{FOV} )}$$

In this numerical example, the SRF in the horizontal direction comes to 2.796.

Given the SRF as now determined in process 44, adjustment of the observed cursor position in process 46 can be carried out by positioning circuitry 25 calculating an adjusted cursor position CUR_{d}, which will be a signed value indicating the adjustment of the cursor position relative to the center location of the positioning target as viewed by pointing device 10. An example of the calculation of this adjustment is:

$${CUR}_{d} = \frac{{TC}_{d} - \frac{\frac{{TCO}_{c} \times {T}_{d}}{{T}_{c}}}{{T}_{c}}}{SRF}$$

For the particular example given above, the value of this adjustment CUR_{d} is −120 pixels. This negative number means that the adjusted cursor position (e.g., cursor position P′ of FIG. 7b) is positioned 120 pixels left of the center of positioning target PT at display 20 (as opposed to its location right of positioning target PT as viewed by pointing device 10).

As described above and as will be recognized by those skilled in the art having reference to this specification, other approaches to the manner in which any of the processes involved in adjusting the displayed movement of a cursor position with a variable sensitivity, depending on such factors as the range of the pointing device from the display and the speed of movement of the pointing device, are also contemplated. For example, referring to FIG. 4, processes 42, 44, and 45 may be performed initially on use of the interactive display system, and perhaps only periodically repeated to adjust operation should the user move so as to change the range from display 20, in which case the positioning loop of positioning process 40, decision 41, and adjustment process 46 would not necessarily include the redetermination of range in process 42 and recalculation of the sensitivity reduction factors in processes 44, 45.

According to these embodiments, an interactive display system and method of operating the same is provided that improves the ability of a user to interact with the system, using a handheld remote device, over a range of distances from the display. More specifically, embodiments provide the user with the ability to control displayed items such as a cursor, icons, or free-form images and text, in a natural manner regardless of his distance from the display, ranging from immediately at the display to at a large distance from the display such as in a ballroom or auditorium.

While one or more embodiments have been described in this specification, it is of course contemplated that modifications of, and alternatives to, these embodiments, such modifications and alternatives capable of obtaining one or more the advantages and benefits of this invention, will be apparent to those of ordinary skill in the art having reference to this specification and its drawings. It is contemplated that such modifications and alternatives are within the scope of this invention claimed herein.

What is claimed is:

1. A method of operating a computer system including a display, comprising the steps of:
from a distance away from the display, pointing a handheld human interface device at a location of the display;
identifying a point-to location on the display corresponding to the location of the display at which the device is pointing;
determining the range of the device from the display;
determining a sensitivity reduction factor responsive to the range; and
responsive to movement of the device, moving a cursor position at the display in a direction corresponding to the movement, by an amount corresponding to the magnitude of the movement of the device adjusted by the sensitivity reduction factor.

2. The method of claim 1, wherein the sensitivity reduction factor increases with increasing distance of the device from the display.

3. The method of claim 2, wherein the step of determining a sensitivity reduction factor comprises:
determining a viewing angle of the screen in a direction at the range;
adding a tolerance angle to the viewing angle to derive a adjusted viewing angle; and
deriving the sensitivity reduction factor from a ratio of the adjusted viewing angle to the viewing angle.

4. The method of claim 2, wherein the step of determining a sensitivity reduction factor comprises:
determining a first viewing angle of the screen in a first direction at the range;
adding a tolerance angle to the first viewing angle to derive a first adjusted viewing angle;
deriving a first sensitivity reduction factor from a ratio of first adjusted viewing angle to the first viewing angle;
determining a second viewing angle of the screen in a second direction at the distance, the second direction perpendicular to the first direction;
adding a tolerance angle to the second viewing angle to derive a second adjusted viewing angle; and
deriving a second sensitivity reduction factor from a ratio of first adjusted viewing angle to the second viewing angle.

5. The method of claim 4, wherein the step of moving the cursor position comprises:
determining movement of the device in a direction corresponding to the first direction;
moving the cursor position in the first direction by an amount corresponding to the magnitude of the movement in the first direction divided by the first sensitivity reduction factor;
determining movement of the device in a direction corresponding to the second direction; and
moving the cursor position in the second direction by an amount corresponding to the magnitude of the movement in the second direction divided by the second sensitivity reduction factor.

6. The method of claim 4, wherein the moving step comprises:
detecting angular movement of the device at inertial sensors in the device, the detected angular movement corresponding to angular movement of the cursor position at the display; and
adjusting the angular movement of the cursor position by the sensitivity reduction factor.

7. The method of claim 2, wherein the step of determining a sensitivity reduction factor comprises:
determining the sensitivity reduction factor from a functional relationship of the sensitivity reduction factor with the range of the device from the display.

8. The method of claim 2, wherein the step of determining the range comprises:
capturing image data at the device representative of at least a portion of the display including a positioning target; and
comparing a size of the positioning target as captured in the image data to a size of the positioning target at the display to determine a viewing angle of the display at the pointing device.

9. The method of claim 1, wherein the moving step comprises:
detecting linear movement of the device at inertial sensors in the device, the detected linear movement corresponding to linear movement of the cursor position at the display; and
adjusting the linear movement of the cursor position by the sensitivity reduction factor.

10. The method of claim 1, wherein the moving step comprises:
detecting movement of the device by capturing image data at the device representative of at least a portion of the display including a positioning target;
determining a physical cursor position from the captured image data, the physical cursor position corresponding to a position at or near the display relative to the positioning target in the field of view of the pointing device; and
adjusting a cursor position at the display from the physical cursor position by the sensitivity reduction factor.

11. The method of claim 1, further comprising:
sensing a speed of movement of the device;
determining a motion sensitivity reduction factor responsive to the speed of movement of the device; and
combining the sensitivity reduction factor responsive to the range with the motion sensitivity reduction factor to produce the sensitivity reduction factor.

12. An interactive display system, comprising:
a computer for generating display image data to be displayed on a display;
graphics output circuitry for generating graphics output signals corresponding to the display image data in a format suitable for display;
a pointing device, comprising:
a hand-held housing; and
one or more sensors for detecting movement of the pointing device; and
positioning circuitry for determining a cursor position of the display at which the pointing device is to control by movement, the positioning circuitry arranged to carry out a plurality of operations comprising:
identifying a point-to location on the display corresponding to the location of the display at which the pointing device is aimed;
determining the range of the pointing device from the display;
determining a sensitivity reduction factor responsive to the range; and
responsive to movement of the pointing device, moving a cursor position in a direction corresponding to the movement, by an amount corresponding to the magnitude of the movement of the pointing device adjusted by the sensitivity reduction factor.

13. The system of claim 12, wherein the sensitivity reduction factor increases with increasing distance of the pointing device from the display.

14. The system of claim 13, wherein the operation of determining a sensitivity reduction factor comprises:
determining a viewing angle of the screen in a direction at the range;
adding a tolerance angle to the viewing angle to derive a adjusted viewing angle; and
deriving the sensitivity reduction factor from a ratio of the adjusted viewing angle to the viewing angle.

15. The system of claim 13, wherein the operation of determining a sensitivity reduction factor comprises:
determining a first viewing angle of the screen in a first direction at the range;
adding a tolerance angle to the first viewing angle to derive a first adjusted viewing angle;
deriving a first sensitivity reduction factor from a ratio of first adjusted viewing angle to the first viewing angle;
determining a second viewing angle of the screen in a second direction at the distance, the second direction perpendicular to the first direction;
adding a tolerance angle to the second viewing angle to derive a second adjusted viewing angle; and
deriving a second sensitivity reduction factor from a ratio of first adjusted viewing angle to the second viewing angle.

16. The system of claim 15, wherein the operation of moving the cursor position comprises:
determining movement of the pointing device in a direction corresponding to the first direction;
moving the cursor position in the first direction by an amount corresponding to the magnitude of the movement in the first direction divided by the first sensitivity reduction factor;
determining movement of the pointing device in a direction corresponding to the second direction; and
moving the cursor position in the second direction by an amount corresponding to the magnitude of the movement in the second direction divided by the second sensitivity reduction factor.

17. The system of claim 15, wherein the one or more sensors comprise inertial sensors detecting angular movement of the pointing device corresponding to angular movement of the cursor position at the display;
and wherein the moving operation comprises:
adjusting the angular movement of the cursor position by the sensitivity reduction factor.

18. The system of claim 13, wherein the operation of determining a sensitivity reduction factor comprises:
determining the sensitivity reduction factor from a functional relationship of the sensitivity reduction factor with the range of the pointing device from the display.

19. The system of claim 13, wherein the one or more sensors comprise:
a camera disposed in the housing; and
video capture circuitry for capturing image data obtained by the camera; and
wherein the operation of determining the range comprises:
capturing image data at the pointing device representative of at least a portion of the display including a positioning target; and
comparing a size of the positioning target as captured in the image data to a size of the positioning target at the display to determine a viewing angle of the display at the pointing device.

20. The system of claim 12, wherein the one or more sensors comprise inertial sensors detecting linear movement of the pointing device corresponding to linear movement of the cursor position at the display;
and wherein the moving operation comprises:
detecting linear movement of the pointing device at inertial sensors in the pointing device, the detected linear movement corresponding to linear movement of the cursor position at the display; and
adjusting the linear movement of the cursor position by the sensitivity reduction factor.

21. The system of claim 12, wherein the one or more sensors comprise:
a camera disposed in the housing; and
video capture circuitry for capturing image data obtained by the camera; and
and wherein the operation of determining the range comprises:
detecting movement of the pointing device by capturing image data at the pointing device representative of at least a portion of the display including a positioning target;
determining a physical cursor position from the captured image data, the physical cursor position corresponding to a position at or near the display relative to the positioning target in the field of view of the pointing device; and
adjusting a cursor position at the display from the physical cursor position by the sensitivity reduction factor.

22. The system of claim 12, wherein the plurality of operations further comprises:
determining a speed of movement of the pointing device;
determining a motion sensitivity reduction factor responsive to the speed of movement of the pointing device; and
combining the sensitivity reduction factor responsive to the range with the motion sensitivity reduction factor to produce the sensitivity reduction factor.
